(19) United States
(12) Patent Application Publication
(10) Pub. No.: US 2015/0379499 A1
(43) Pub. Date: Dec. 31, 2015

(54) MOBILE PAYMENT METHOD AND SYSTEM FOR SCHEDULED PAYMENTS

(71) Applicants: Dongyan Wang, Beijing (CN); Zejian Lu, Beijing (CN); Bo Luan, Beijing (CN)

(72) Inventors: Dongyan Wang, Beijing (CN); Zejian Lu, Beijing (CN); Bo Luan, Beijing (CN)

(21) Appl. No.: 14/411,800

(22) PCT Filed: Jun. 29, 2012
(86) PCT No.: PCT/CN2012/077878

§ 371 Date: Sep. 21, 2015

(51) Int. Cl. G06Q 20/32; H04M 1/725

(52) U.S. Cl. CPC G06Q 20/3221; G06Q 20/3223; H04M 1/72566

(57) ABSTRACT

A mobile payment method is provided for scheduled payments. A mobile terminal of a user receives a reminding message, the content of which includes information as to a scheduled payment of the user, the mobile terminal automatically analyzes the content of the message and extracts from the content payment information such as a deadline for payment and an amount to be paid. The mobile terminal stores the extracted payment information for future consultation by the user.

### CROSS-REFERENCE TO RELATED APPLICATIONS

This application is a Section 371 National Stage Application of International Application No. PCT/CN2012/077878, filed Jun. 29, 2012, the content of which is incorporated herein by reference in its entirety, and published as WO 2014/000257 on Jan. 3, 2014, in English.

### FIELD OF THE DISCLOSURE

The present application relates to the field of mobile payment on mobile devices.

### BACKGROUND OF THE DISCLOSURE

Banks, insurance companies are already using the SMS through telecom network to periodically remind subscribers of regular payments that they are to perform on a pre-set schedule.

This kind of SMS is generally sent out two or three weeks before the transaction deadline.

Such reminders to pay in time have proved to be very useful for the end users.

However, end users receiving such reminders still have to remember by themselves the exact deadline for payment and the exact amount to pay.

To this end, end users can re-check from time to time in their SMS history the content of the SMS reminder received. This however is not convenient for them, in particular when the SMS has been received two or three weeks before. It is therefore not unusual that end users still contact again the banks or insurance companies to get the exact amount to pay and the exact payment deadline.

Further, as to the payment, it will be noted that such reminding systems for preset schedule payments still need end users to perform a payment either at the bank or through logging on the internet before the deadline date. The end user could even sometimes forget to pay, thereby causing unnecessary trouble for both service providers (banks, etc.) and the end user itself.

It has recently been proposed in US 2011/0022515 a mobile payment system for scheduled payments.

Such a system however is rather complex to implement as it requires a specific provider dedicated and adapted for this mobile payment system, said provider centralizing and administering all the exchanges with a mobile client, a merchant information computer system and a specific mobile payment host which communicates with this provider and performs the payment through a classical automated clearing house (ACH).

Further, the transactions performed are triggered through a simple SMS sent by end-users and cannot be considered as secured transactions on the end users' side.

Therefore there is a need for a simplified automatic mobile payment system for scheduled transactions, permitting end users to deal with such transactions in an efficient and flexible way.

There is also a need for an automatic payment system for scheduled transactions presenting enhanced security functionalities.

### SUMMARY OF THE INVENTION

According to a first aspect of the invention, it is proposed a mobile payment method for scheduled payments, comprising the following steps executed by a mobile device/terminal:
receiving a reminding message, the content of which comprises information as to a scheduled payment of the user,
analyzing the content of said message and
extracting from said content payment information such as a deadline for payment and an amount to be paid,
storing said extracted payment information for future consultation by the user.

Such a system is easy to implement and will help users to be reminded of their scheduled transaction with less effort.

Further, the content of the message received can comprise a service provider signature, said content being processed by the mobile terminal to extract said service provider signature and to check the eligibility of the message.

This service signature permits to improve service quality of service providers and to enhance security of the payment.

Also, the payment information can be stored on a calendar unit of the mobile terminal, said calendar unit triggering the display on the mobile terminal of at least one reminding message comprising at least part of the extracted payment information stored.

A program application can be installed on said mobile terminal by a mobile network operator, said application performing the analyzing of the messages received and extracting the payment information. Said program application can manage the display of the at least one reminding message as well as the exchanges with a server of the mobile network operator when the user chooses to pay through his mobile terminal.

The mobile terminal can also comprise a secure element, a secured payment being processed through said secure element when the user chooses to pay through his mobile terminal.

In particular, a security application can be installed on said mobile terminal by a mobile network operator server, said application running on the secure element.

The security mechanism thus proposed therefore guarantees safe transactions.

According to other aspects of the invention, it is also proposed
a mobile terminal for mobile telecommunication network, said terminal comprising a message analyzer automatically analyzing the content of reminding messages received, said analyzer extracting from messages which content comprises information as to scheduled payment of the user, information such as a deadline for payment and an amount to be paid, and storing said extracted payment information for future consultation by the user;
a mobile payment system comprising a service provider server, a mobile network operator server, and a bank server exchanging through an IT platform and at least one mobile terminal as above mentioned, said mobile terminal exchanging with the mobile network operator server during payment processing;
programs to be run on a mobile terminal, wherein said program comprises instructions to perform steps of the method of the invention, when said program is run by a mobile terminal processor;

### DESCRIPTION OF THE DRAWINGS

These and other advantages of the present invention will be readily understood with reference to the following description and attached drawings wherein:

FIG. 1 illustrates the general architecture of a mobile payment system according to a possible embodiment of the invention.

FIG. 2 is a software block diagram illustrating a possible implementation in the mobile terminal.

FIG. 3 is a flow chart illustrating a possible mobile payment service subscription.

FIG. 4 is a flow chart illustrating a possible subscription by a user to new services or an update of existing services by the user.

FIG. 5 illustrates an example of a service provider service list.

FIG. 6 is a flow chart illustrating a possible scheduled mobile payment software implementation.

FIGS. 7a, 7b and 7c illustrate possible examples of transaction prompts (FIGS. 7a, 7b) and of calendar display (FIG. 7c).

FIG. 8 is a flow chart illustrating a possible payment with a virtual account associated with a secure element of the mobile terminal.

FIG. 9 is a flow chart illustrating a possible payment with a bank account associated with a secure element of the mobile terminal.

### DETAILED DESCRIPTION

### General System Architecture

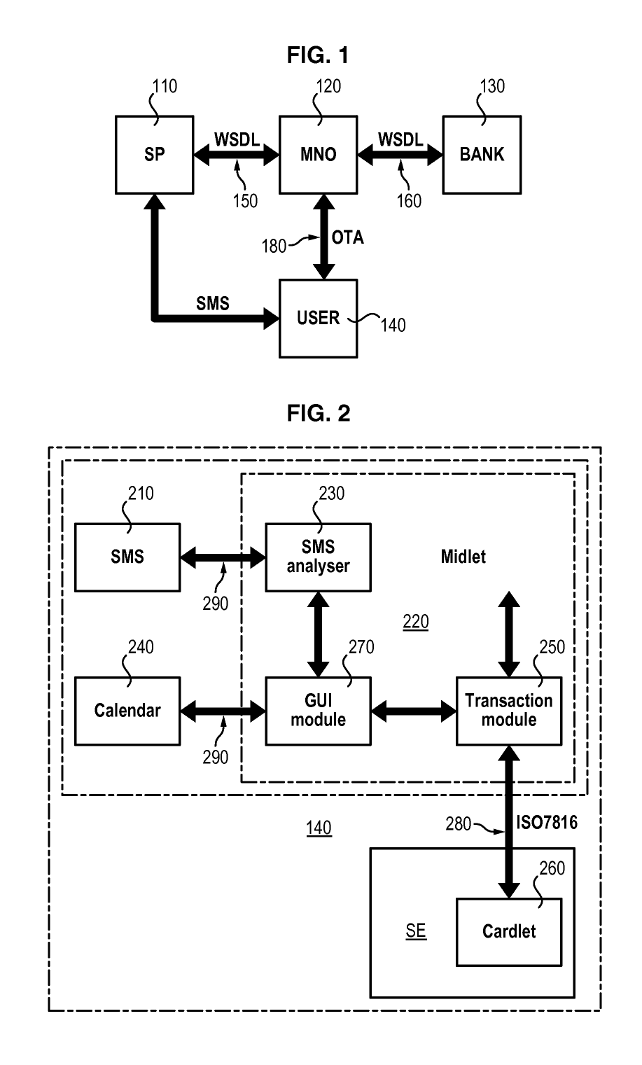

The system architecture illustrated on FIG. 1 comprises various servers 110, 120, 130 of at least a Service Provider SP, a Mobile Network Operator MNO and of a bank. Service provider SP (server 110) is a company using the payment system to promote their business. It can for example be a gas or telephone company, or even a bank to which end users have to reimburse credits, e.g. from credit cards.

An IT service platform 150, 160 based on WSDL is used to deal with the exchanges and transaction process as performed by servers 110, 120,130 at the MNO, the bank and the service provider SP. The interfaces of this IT platform based on WSDL technology define the requests, responses and notifications exchanged between the service provider SP and the mobile network operator MNO (exchanges 150 between servers 110, 120), as well as those between the mobile network operator MNO and the Bank (exchanges 160 between servers 110, 120).

An end user equipped with a mobile terminal 140 uses the automatic payment service for scheduled transactions promoted by the service provider SP.

To this end, an application is installed on mobile terminal 140, part of it being a java card application run in a secure element SE on the mobile device, an other part of it being a midlet installed on the mobile device.

Mobile terminal 140 receives SMS reminding messages sent by server 110 of service provider SP. As described hereunder, it extracts information as to the payment scheduled from said message and exchanges with MNO server 120 for the payment.

The interface between MNO server 120 and the mobile terminal 140 of the user is based on OTA (Over the Air) technology, WAP or any other technology permitting to manage the data and applications of the circuit card (UICC) of the terminal via the air interface.

Software Architecture in Mobile Terminal 140

The architecture illustrated on FIG. 2 comprises an SMS unit 210, a midlet unit 220, a calendar unit 240 and a cardlet unit 260.

SMS Unit 210

Unit 210 is a classical SMS unit administrating the SMS emission, reception and display of mobile terminal 140. It can be realized by existing technology available for mobile devices.

Calendar Unit 240

Calendar unit 240 is for example a typical calendar unit of the type classically implemented on mobile devices. It stores reminding information transferred to it by midlet 220 through GUI (Graphical User Interface) module 270 of said midlet 220 and triggers said midlet 220 so that it displays at given deadlines reminding messages on mobile terminal 140. Therefore, when a reminded date is pending, a transaction prompt will show up from time to time in the message bar of mobile terminal 140 prompting the user to pay or cancel. If ‘pay’ is chosen, this information will be passed into GUI module 270 which will trigger the transaction module. If ‘cancel’ is selected, this transaction information will be marked as ‘cancelled’.

The user can also use calendar 240 to check at any time the transaction information stored.

Midlet 220

Midlet 220 is an application run on mobile 140, which includes three modules: an SMS analyzer 230, a transaction module 250 and GUI module 270.
SMS analyzer 230

SMS analyzer 230 is automatically triggered when a SMS is received through SMS unit 210. It analyses the SMS received to extract its SMS source number and compares said source number with authorized source numbers pre-stored or updated in a table (local SP SMS number registration table described later on) stored in mobile device 140, to verify its eligibility.

Said source numbers correspond to the mobile phone numbers that sent the SMS to the end users, these numbers being for example special numbers offered by the MNOs to the service providers SP.

When the SMS eligibility is verified, the analyzer 230 extracts from the SMS content payment schedule information, such as SP code, payment deadline, payment amount, and currency type. The received deadline and payment amount will be used as the default parameters, the user still having the flexibility to change it based on practical context via the module GUI 270. The preferred payment amount and deadline information are then sent to calendar unit 240.
SMS format

In order to conveniently extract the transaction information, a formatted SMS is used which for example contains 7 elements: transaction type, deadline, amount, currency type, polite greeting, remaining time, and website.
The “Transaction Type” data indicates the kind of transaction the user needs to pay (e.g. telephone rate payment, credit card repayment).
The “Deadline” data corresponds to the last date when the transaction has been realized.
The “Amount” data indicates the amount that the user needs to pay to the service provider SP.
The “Currency Type” data corresponds to the transaction currency type, such as USD, RMB, EURO, etc.
The “Polite Greetings” data are business etiquette.
The “Remaining Time” data indicates the time left for implementation of the transaction date.
The “Website” data provides the official website where users can check the detailed transaction information by their internet account.

A sample of formatted SMS may look like below:
“Dear Mr. Alter, this is the Citibank credit card center, your credit card repayment date is nearly up, please repay 200.00USD for your credit card before Apr. 12, 2012. There are 7 days left to the payment date, you can check more detailed information at our official website: www.citibank.com.”

This message is formatted as the table below shows:

TABLE 1
Formatted SMS content

| Polite | Transaction | | Currency | | Remaining | |
|---|---|---|---|---|---|---|
| greeting | type | Amount | type | Deadline | time | Website |
| Dear | credit | 200.00 | USD | Apr. 12, | 7 days | www.citibank.com |
| Mr. Alter | card | | | 2012 | | |
| | repayment | | | | | |

The SMS source number with SP signature also needs to be formatted within the SMS content as follows:

xxxxxx/####/**

where
‘xxxxxx’ represents the MNO specific code,
‘####’ represents the SP specific code, and
** represents the transaction type distinguishing different services that can be provided by the service provider SP.

As to the transaction type of the SMS source number, it can for instance be defined as follows:
Credit card reimbursement corresponds to transaction type 1;
Water payment corresponds to transaction type 2;
Electricity payment corresponds to transaction type 3;
Insurance payment corresponds to transaction type 4.

A sample of formatted SMS source number may be: 100876955301

TABLE 2
example of SMS number with SP signature

| MNO specific code | SP specific code | Transaction type |
|---|---|---|
| 100876 | 9553 | 01 |

Transaction module 250

Transaction module 250 deals with the transaction process in collaboration with cardlet unit 260 and server 120 of the MNO. When mobile terminal 140 of the user confirms the payment, said module 250 asks the user to input PIN code and then communicates to secure element SE to withdraw the amount. If this operation is successful, said module connects to server 120 of the MNO to confirm this transaction. The MNO server 120 will then return a successful message. All the transaction data are encrypted for the sake of security.
GUI module 270

GUI module 270 is to interact with users, transaction modules and calendar modules to set up the reminding date or payment amount, input the PIN code and SP bank account, display the transaction information, etc.

Cardlet Unit 260

Cardlet unit 260 is a java card application running on secure element SE (UICC, SD . . . ). Said secure element SE comprises a dedicated area where an account is stored and which is such that the security of transaction process can be guaranteed.

Such an account is of the type classically used for payments through SMS. It is managed by a specific service provider, which might be different from service provider SP. It can be charged by the client from their bank account.

The credit card credentials are also stored with the cardlet unit 260, said credit card credential being related to the user's credit card and being used in the authentication process between mobile terminal 140 of the user, server 120 of the MNO and server 130 of the bank. The mobile network operator MNO is responsible for the installation of cardlet unit 260, as well as for its updating or deletion.

Interfaces Involved in the Software Architecture in Mobile Terminal 140 Interface 290

The SMS number and content are transferred via the interface between SMS unit 210 and midlet 220. The payment schedule information (SP code, payment deadline, payment amount, and currency type) are transferred via the interface between calendar unit 240 and midlet 220. This kind of interface can be realized by existing technology available on mobile devices.

For example, in case of mobile terminals of the Android type, said interface can use “Intent” which is one of Android components that can be used to transmit data between different applications or wake up another application.

Midlet 220 will add an event to calendar unit 240. When said event is triggered, said calendar unit 240 wakes up midlet 220. Said midlet can be also triggered by an SMS event.

Interface 280

Interface 280 manages the exchanges between the secure element SE and in particular cardlet unit 260. The Application Protocol Data Unit (APDU) commands it uses are based on ISO 7816 protocol, which is an internationally accepted standard for smart cards. ISO 7816 is a family of standards primarily dealing with aspects of smart card interoperability regarding communication characteristics, physical properties, and application identifiers of the implanted chip and data.

Mobile Payment Service Subscription

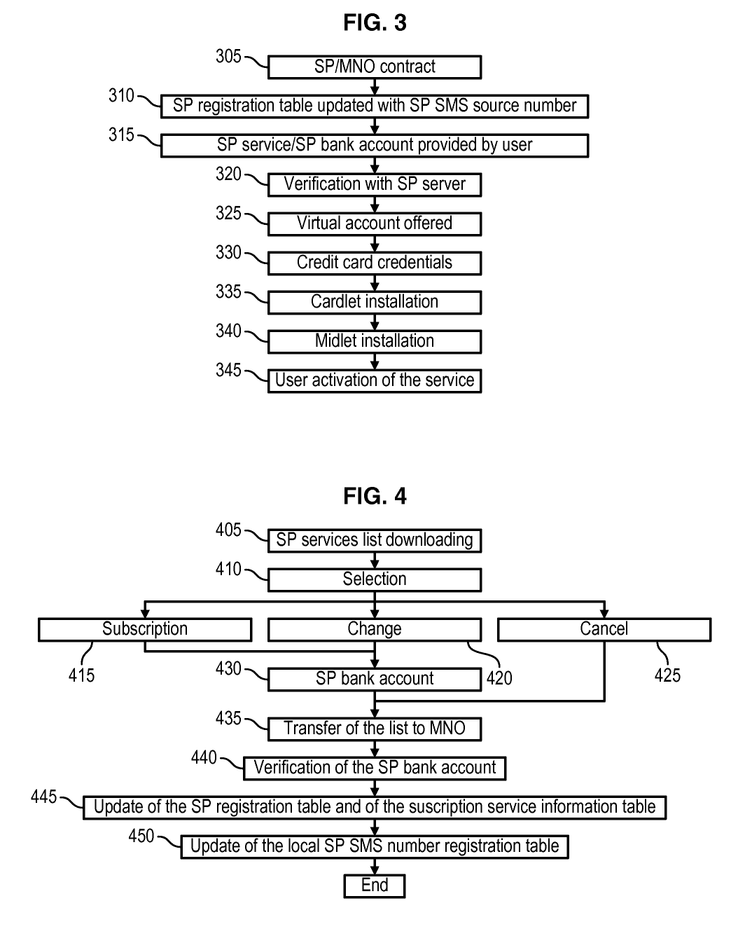

FIG. 3 provides an example of flow chart for mobile payment service subscription.

At step 305, a service provider SP signs a contract with a Mobile Network Operator MNO to provide the service.

At step 310, operator MNO assigns an SMS source number to service provider SP based on the contract and updates the SP registration table in MNO server 120.

SP Registration Table with MNO

This table describes the detail information of service providers SP which have contracted with operator MNO.

The SP registration table includes data identifying the MNO operators, the service provider SP, the transaction type and the service provider bank account. The SMS source number information is provided to MNO when joining the service.

The SP Registration Table in MNO server 120 may look like below:

TABLE 3
SP Registration table in MNO server

| | MNO | SP | | |
|---|---|---|---|---|
| Service | specific | specific | Transaction | SP default bank |
| Identifier | code | code | type | account |
| 001 | 100876 | 9553 | 01 | 6222566223654659 |
| 002 | 100876 | 3126 | 02 | |

The “Service Identifier” data represents the combined indicator of a service with unique service provider and transaction type. This identifier could be assigned automatically by database system in MNO server 120.
The “SP default bank account” data are data identifying the account to which the payment of the user is to be transferred. Some service providers SP only have one unique bank account, such as some gas companies, or water supply companies. In this situation, the service provider SP will provide the default bank account when signing the contract with MNO. Other service providers SP may use different accounts for different users, for example for credit card repayment. In this situation, end users will provide to the MNO the accounts to which the payment should be made. Transfer of the funds will be made to separate accounts for different users. For the sake of security, MNO should turn to service provider SP to check the eligibility of the account provided by the end user.

As shown in Table 3, service 001 has a default account while SP default bank account of service 002 stays empty, which means that when end users subscribe to service 002, they will have to provide to MNO the SP Bank Account to which the transfers will have to be made.

Local SP SMS Number Registration Table

The Local SP SMS number registration table stored in an encrypted form on mobile terminal 140 provides data for the identification of the MNO, the service provider SP. Said table may be stored with midlet 220 or cardlet unit 260. In particular, it can be pre-stored with midlet 220 or cardlet unit 260 while installing the midlet. It can also be updated by communication with MNO. When MNO server 120 adds a new reminder SMS source number with SP signature in SP registration table at server side, it is responsible for updating the Local SP SMS number registration table in the user's mobile terminal 140 by OTA or WAP or some other technology. The registration table in mobile terminal 140 may look like below:

TABLE 4
Local SP SMS number registration table in mobile terminal 140

| Service | MNO specific | SP specific | Transaction |
|---|---|---|---|
| Identifier | code | code | type |
| 001 | 100876 | 9553 | 01 |
| 002 | 100876 | 3126 | 02 |

Subscription Service Information Table in MNO Server

At step 315, when a user subscribes the service, user should choose which SP service to use and offer corresponding SP bank account if needed. A record will be added into the Subscription information table stored and updated in MNO server 120.

Service Information table is shown as follows:

TABLE 5
Subscription Service Information table in MNO server

| User | Service | |
|---|---|---|
| Identifier | Identifier | SP Bank Account |
| A | 001 | 6222566223654659 |
| A | 002 | 0123456789011111 |
| B | 001 | 6222566223654659 |

The Subscription Service Information table associates a user with a service.

The “SP Bank Account” data identify the account to which the end user wants to transfer the fund. Service provider SP default Bank Account in Table 3 can be used as SP bank Account. As mentioned above, some SPs may have just one unique account. In this case, SP Bank Account is equal to SP default Bank Account and the end user does not have to provide an additional account. However, if the SP default

Bank Account is empty, the end user has to provide the SP bank account when subscribing the service.

At step 320, MNO server 120 communicates with SP server 110 to verify SP bank account via WSDL 150 and completes the SP registration table in the MNO server 120.

At step 325, MNO server 120 offers a virtual account associated with secure element SE on mobile terminal 140 or end user can associate the user's bank account (debit card, credit card) with the secure element SE on mobile terminal 140. It will be here noted that MNO server 120 stores a subscription user information table associating the user's mobile phone number with said virtual account data.

At step 330, after user has provided their credit card information, MNO server 120 will create the credit card credentials in the cardlet application to be installed on mobile terminal 140. Said credit card credentials relate for example to the user's credit card. When user chooses to pay with credit card, said credentials will be used for purpose of authentication in the verification exchanges between mobile terminal 140 and MNO server 120.

At step 335, MNO server 120 installs cardlet unit 260 in secure element SE on user's mobile phone (secure element SE may be installed on UICC, SD card . . . ) via OTA.

At step 340, mobile terminal 140 downloads and installs midlet 220 on said terminal from the MNO server 120 through OTA, WAP, or any other technology (SMS for example).

At step 345, the end user activates the service through their mobile terminal 140.

User Subscription to New Services or Update of Existing Services

FIG. 4 illustrates the subscription to new services or the update of existing services.

At step 405, after installation of midlet 220 and of cardlet unit 260 on mobile terminal 240, and after user activates the service, transaction module 250 downloads the list of all the SPs' services from MNO 120 server and GUI module 270 displays it to end user.

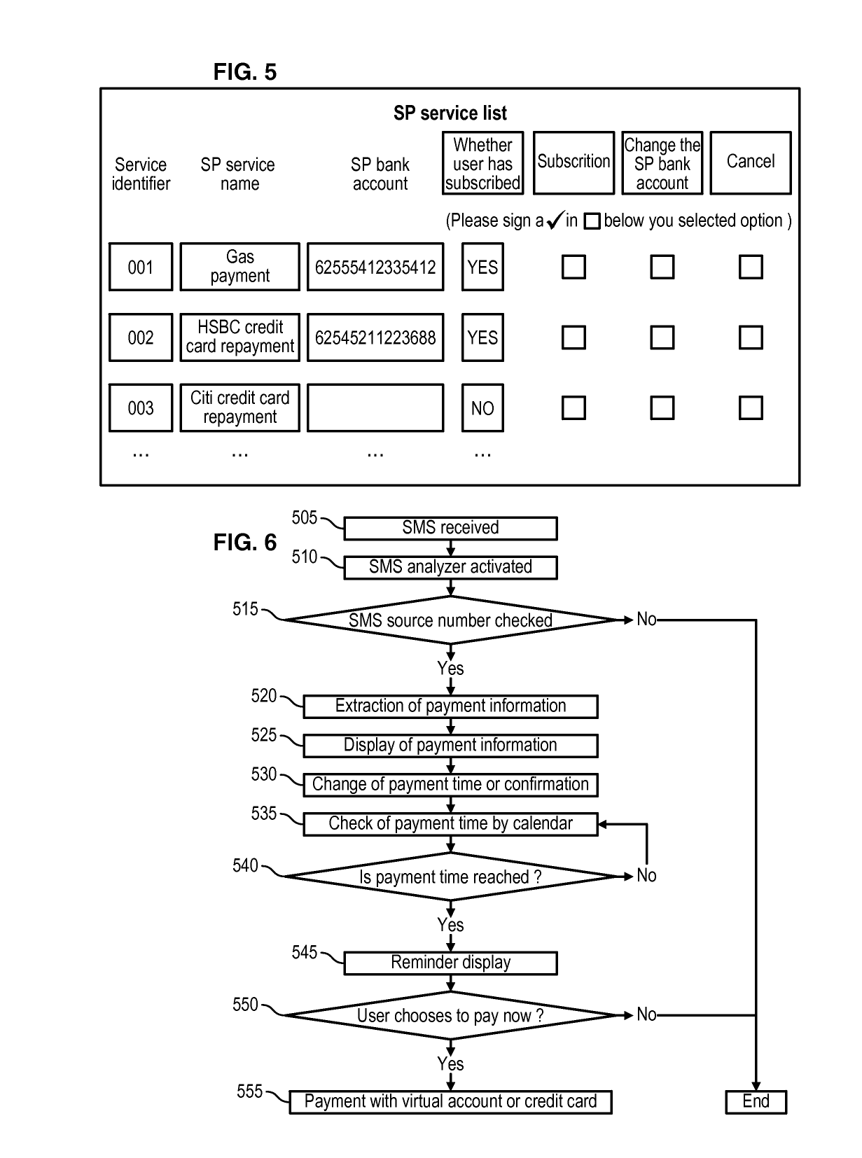

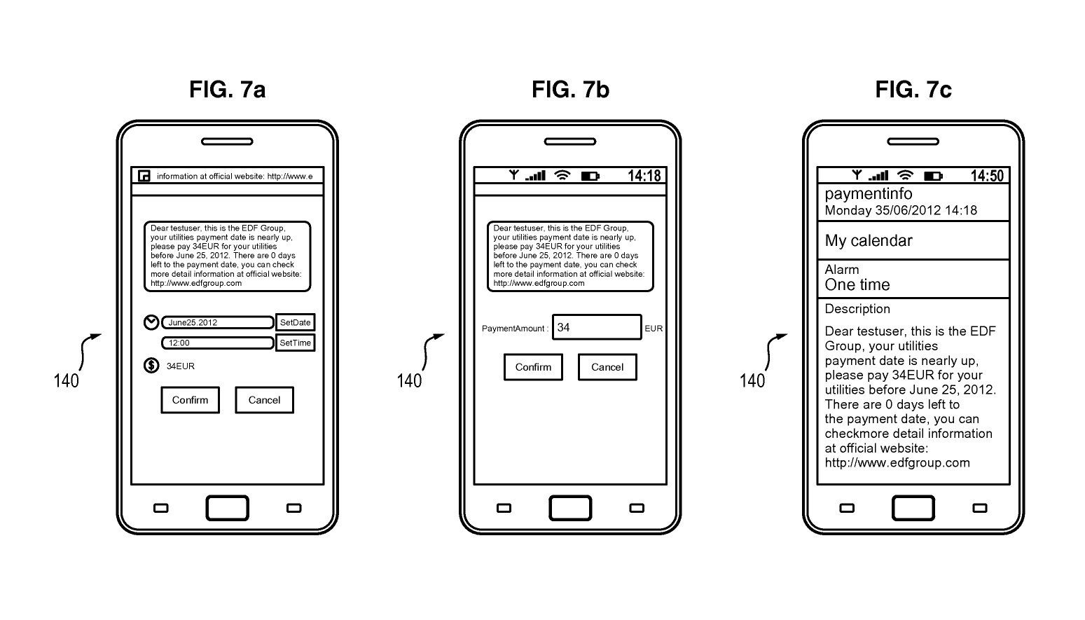

The SP service list (FIG. 5) is provided by MNO server 120. User can subscribe the SP service, change the SP bank account or cancel the SP service on the SP service list.

At step 410, user selects the SP service to which he wants to subscribe, or which he wants to cancel or update from the list.

At step 415, user chooses to subscribe the selected SP service.

At step 420, user chooses to change the selected SP service Bank account.

At step 425, user chooses to cancel the selected SP service.

At step 430, if user chooses to subscribe the selected SP service or change the SP service Bank account, he will enter the SP bank account or use the SP default bank account.

At step 435, transaction module 250 transfers the list to MNO server 120.

At step 440, MNO server 120 communicates with the SP server 110 to verify the SP bank account via WSDL interface 150.

At step 445, MNO server 120 updates the SP registration table and subscription service information table in said MNO server 120 and returns the results to mobile terminal 140.

At step 445, when transaction module 250 receives the successful feedback, it will update the Local SP SMS number registration table in mobile terminal 140.

Scheduled Mobile Payment Software Implementation

As illustrated on FIG. 6, various steps of the mobile payment implementation may be as follows:

At step 505, SMS module 210 receives a SMS.

At step 510, SMS analyzer 230 is activated by SMS module 210, SMS analyzer 230 acquires the information of SMS source number and SMS content from SMS module 210.

At step 515, SMS analyzer 230 checks if the SMS source number has been registered by comparing with the number in the Local SP SMS number registration table. The detail Local SP SMS number registration table can be seen in Table 4.

At step 520, if the SMS number is matched, SMS analyzer 230 extracts the payment schedule information (SP code, payment deadline, payment amount, and currency type) and sends the payment schedule information to GUI module 270. If the SMS number is not matched, no further action will be taken.

At step 525, GUI module 270 is invoked by SMS analyzer 230, the payment schedule information will be shown on the GUI module 270 and displayed on the screen of mobile terminal 140.

At step 530, according to the payment schedule information, user can change the payment time which is before the deadline and amount on the GUI module 270.

After user confirms the information, GUI module 270 adds the confirmed schedule information to calendar unit 240.

At step 535 and 540, calendar unit 240 checks if the payment time is reached. If the payment time is not reached, calendar unit 240 will keep waiting.

At step 545, if the payment time is approaching, calendar unit 240 will remind user to pay. Midlet 220 is activated by said calendar unit 240 and midlet 220 invokes the GUI module 270.

At step 550, user can choose to pay now on the GUI module 270 or not. If user chooses not to do so, no further action will be taken.

At step 555, if user chooses to pay now, he is given the choice to pay with virtual account or credit card.

Payment Types

Two payment types can for example be proposed:
Type 1: payment with the virtual account;
Type 2: payment with the credit card or debit card associated with the secure element SE on the mobile device.

Payment with the Virtual Account

The MNO should provide a virtual account system.

Under the agreement or contract between Service Providers SP and the mobile network operator MNO, if the service provider SP has only one unique account, the service providers are expected to provide the bank account for receiving the transaction from the users; the MNO operators are on their side expected to provide the special SMS source number to associate with each of the service providers. The service provider SP signature table includes both information (the Special SMS source number) is stored in MNO server 120 after the agreement.

The virtual account is an account that enables users to deposit, withdraw and transfer funds to any cooperating service provider SP. User can also transfer fund to this account from other real bank accounts. This virtual account resides in secure element SE of mobile terminal 140. Said secure element SE makes the payment very secured and synchronizes with the MNO's virtual account system. It is the MNO operator responsibility to maintain the virtual account system. If user wants to pay via this account, the MNO will transfer fund from this account to SP service bank account provided by user or SP.

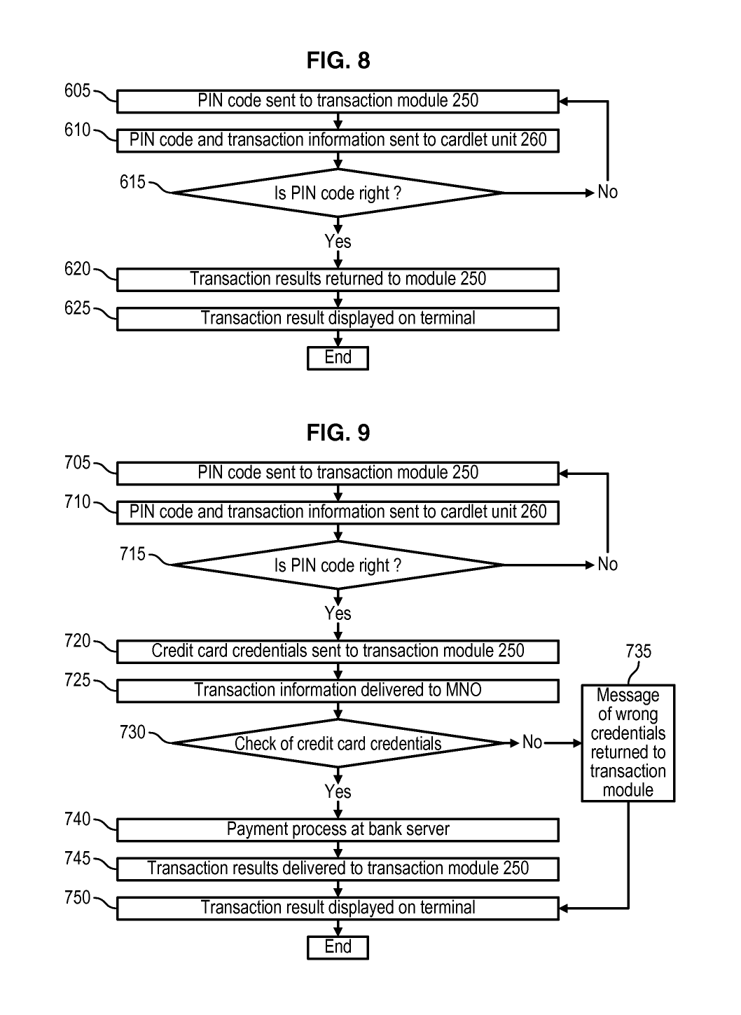

A payment process with a virtual account associated with the secure element SE is described hereunder with reference to FIG. 8.

At step 605, user enters PIN code and SP bank account on the GUI module 270, GUI module 270 sends the PIN code to transaction module 250.

At step 610, transaction module 250 communicates with cardlet unit 260 by ISO 7816 protocol. Cardlet unit 260 is selected by the APDU from transaction module 250, transaction module 250 sends the PIN code and transaction information (payment amount) to cardlet unit 260.

At step 615, cardlet unit 260 checks if the PIN code is right. If the PIN code is wrong, user will re-enter the PIN code again.

At step 620, if the PIN code is right, cardlet unit 260 will deduct the amount and return the transaction result (SP code, transaction amount, currency type, transaction date and account balance) to transaction module 250. At this step, depending on the system implementation, the transaction module 250 can connect to the MNO server 120 to synchronize the virtual account instantly or later (for example, the end of the day).

Below is a transaction table in the MNO server 120:

TABLE 6
Transaction table

| User | Service | | | | Virtual |
|---|---|---|---|---|---|
| iden- | Iden- | | Payment | Payment | account |
| tifier | tifier | SP bank account | amount | date | balance |
| A | 001 | 622145444223332 | $100.00 | 2012 | $1000.00 |
| | | | | Apr. 10 | |
| A | 002 | 622554545451111 | $50.00 | 2012 | $950.00 |
| | | | | Apr. 11 | |

The transaction information table records all transaction information which may include (but is not limited to) the transaction date, transaction amount, which user, which service, and SP's bank account. With this table, MNO can provide transaction history search service for both service provider SP and the user. This table is used when the payment is implemented by Type 1 transaction via virtual account.

At step 625, transaction module 250 delivers transaction information to GUI module 270. GUI module 270 will show the transaction result.

Payment with the Bank Account

FIG. 9 is the flow chart of payment with the bank account associated with the secure element SE.

At step 705, user enters PIN code on the GUI module 270, GUI module 270 sends the PIN code to transaction module 250.

At step 710, transaction module 250 communicates with cardlet unit 260 by ISO 7816 protocol. Cardlet unit 260 is selected by the APDU from transaction module 250, transaction module 250 sends the PIN code to cardlet unit 260.

At step 715, cardlet unit 260 checks if the PIN code is right. If the PIN code is wrong, user will re-enter the PIN code again.

At step 720, if the PIN code is right, cardlet unit 260 sends the credit card credentials and transaction information in encrypted form to transaction module 250.

At step 725, transaction module 250 delivers transaction information (credit card credentials, SP bank account, payment amount and currency) to MNO in encrypted form.

At step 730, MNO server 120 will check if credit card credentials are eligible.

At step 735, if the credit card credentials are not eligible, MNO server 120 returns the message of wrong credit card credentials to transaction module 250.

At step 740, if the credit card credentials are eligible, MNO server 120 will communicate with bank 130 to finish the payment process in bank server. Bank 130 will return the transaction result (SP code, credit card balance, payment amount, payment date, and currency type) to MNO server 120.

At step 745, MNO server 120 delivers the transaction result to transaction module 250.

At step 750, transaction module 250 delivers transaction information to GUI module 270. GUI module 270 will show the transaction result.

Although the present disclosure has been described with reference to one or more examples, workers skilled in the art will recognize that changes may be made in form and detail without departing from the scope of the disclosure and/or the appended claims.

1. A mobile payment method for scheduled payments, comprising the following acts executed by a mobile device:
receiving a reminding message, the content of which comprises information as to a scheduled payment of a user,
analyzing the content of said message,
extracting from said content payment information, including a deadline for payment and an amount to be paid, and
storing said extracted payment information for future consultation by the user.

2. The mobile payment method according to claim 1, wherein the content of the message received comprising a service provider signature, the method further comprises the steps of extracting said service provider signature and checking the eligibility of the message.

3. The mobile method according to claim 1, wherein the payment information is stored on a calendar unit of the mobile terminal, said calendar unit triggering the display on the mobile terminal of at least one reminding message comprising at least part of the extracted payment information stored.

4. The mobile payment method according to claim 1, wherein a mobile network operator provides a virtual account system and comprises a server which stores a record table recording all transaction information performed through said virtual account system.

5. The mobile payment method according to claim 4, comprising an act of sending to the mobile network operator transaction information from a security application of the mobile terminal, said information comprising credentials of the mobile terminal, said mobile network operator checking said credentials before communicating with a bank server for further processing of the payment.

6. The mobile payment method according to claim 4, wherein a mobile network operator server stores a service providers registration table, said table including data identifying the mobile network operator, the service providers, the transaction type, and, when given, the service provider bank account to which the payment of the user is to be transferred, and wherein the service provider signature included in the content of the reminding message is extracted from said table.

7. The mobile payment method according to claim 4, wherein the mobile terminal stores a local service provider number registration table comprising specific codes related to the mobile network operator and the service providers as well as information as to the transaction type.

8. A mobile terminal for mobile telecommunication network, said terminal comprising:
a non-transitory computer-readable medium; and
a message analyzer automatically analyzing content of reminding messages received, said analyzer extracting from messages which content comprises information as to scheduled payment of a user, information including a deadline for payment and an amount to be paid, and storing said extracted payment information in the non-transitory computer-readable medium for future consultation by the user.

9. A mobile payment system comprising:
a service provider server, a mobile network operator server, and a bank server exchanging through an IT platform; and
at least one mobile terminal according to claim 8, said mobile terminal exchanging with the mobile network operator server during payment processing.

10. A non-transitory computer-readable medium comprising a program stored thereon to be run on a mobile terminal, wherein said program comprises instructions to perform a payment method for scheduled payments, when said program is run by a processor of the mobile terminal, wherein the method comprises the following acts:
receiving a reminding message, the content of which comprises information as to a scheduled payment of a user,
analyzing the content of said message,
extracting from said content payment information, including a deadline for payment and an amount to be paid, and
storing said extracted payment information for future consultation by the user.

11. The non-transitory computer-readable medium of claim 10, wherein:
a mobile network operator provides a virtual account system and comprises a server which stores a record table recording all transaction information performed through said virtual account system; and
wherein the method further comprises sending to the mobile network operator transaction information from a security application of the mobile terminal, said information comprising credentials of the mobile terminal, said mobile network operator checking said credentials before communicating with a bank server for further processing of the payment.
